(19) United States
(12) Patent Application Publication
(10) Pub. No.: US 2015/0013545 A1
(43) Pub. Date: Jan. 15, 2015

(54) BEVERAGE VENDING MACHINE AND OUTFLOW MODULE FOR SUCH A BEVERAGE VENDING MACHINE

(71) Applicant: Schaerer AG, Zuchwil (CH)

(72) Inventors: Peter Egli, Herrenschwanden (CH); André Lüssi, Jegenstorf (CH); Bruno Mosimann, Burgdorf (CH); Bruno Aeberhard, Zuchwil (CH)

(21) Appl. No.: 14/379,114

(22) PCT Filed: Feb. 12, 2013
(86) PCT No.: PCT/EP2013/052779

§ 371 Date: Aug. 15, 2014

(30) Foreign Application Priority Data
Mar. 9, 2012 (CH) 00342/12

(51) Int. Cl. A47J 31/46; A47J 31/42

(52) U.S. Cl. CPC A47J 31/46; A47J 31/42
USPC 99/286; 222/129.1

(57) ABSTRACT

A beverage vending machine has a housing, in which first means for brewing and dispensing a coffee beverage prepared using freshly ground coffee are housed. Flexible configuration is made possible in that the first means have a modular construction and comprise at least one base module for brewing the coffee beverage and a separate outflow module for dispensing the coffee beverage, which are in fluid connection with one another by means of one or more fluid interfaces.

### TECHNICAL FIELD

The present invention concerns the field of beverage vending machines, and relates to a beverage vending machine according to the preamble of Claim 1. The present invention further relates to an outflow module for such a beverage vending machine.

### BACKGROUND INFORMATION

Self-service beverage vending machines are known in the prior art which are manufactured in large numbers at relatively low cost. Such vending machines offer a user various freshly prepared beverages, for example cafe au lait, cappuccino, latte macchiato, hot chocolate, instant soup, etc., at a reasonable price. After payment using a payment system such as a currency validation system, an electronic payment system, etc., the user is provided with the desired beverage in a drinking cup, for example, which is often automatically provided upon purchase of the beverage. However, the quality of the beverages, in particular coffee beverages, in self-service beverage vending machines is not always satisfactory, since the beverage is prepared by mixing powder with hot water. The use of powder, however, has the advantage that a comparatively large number of different beverages may be cost-effectively provided.

High-quality beverages are offered to a user in localities such as bars or restaurants, in which the beverage is prepared using a hand-operated, high-quality specialty machine, for example. High-quality coffee beverages may be prepared in particular using hand-operated coffee machines. However, these machines require a significant level of effort for operation and maintenance, and are difficult for untrained persons to operate. Although beverages prepared in this way are of high quality, they are relatively costly.

Beverage vending machines for preparing low-cost high-quality coffee beverages are likewise known. Such beverage vending machines are manufactured based on a specification which meets the requirements of a given location or location category. Location categories include, for example, schools, workplaces, recreational centers, museums, offices, etc. Depending on the location or location category, it may be necessary to offer fresh milk, powdered milk, several varieties of coffee, or additives such as powdered chocolate or syrup. After the requirements are established, the components of the self-service coffee machine are selected and used to produce the appropriate self-service coffee vending machine which provides the desired selection of beverages.

However, such beverage vending machines are not as well suited for mass production, since the specifications for various locations or location categories are very different. In order to meet all the requirements of locations or location categories, an unmanageable number of different beverage vending machines would be necessary.

### DESCRIPTION OF THE INVENTION

It is an object of the invention, therefore, to provide a beverage vending machine which may be flexibly configured and which is characterized by simple operation and maintenance.

It is a further object of the invention to provide an outflow module for such a beverage vending machine.

These and further objects are achieved by the features of Claims 1 and 16.

The beverage vending machine of the invention, having a housing in which first means for brewing and dispensing a coffee beverage prepared using freshly ground coffee are accommodated, is characterized in that the first means have a modular construction and include at least one base module for brewing the coffee beverage, and a separate outflow module for dispensing the coffee beverage, which are in fluidic connection with one another via one or more fluid interfaces.

One embodiment of the beverage vending machine according to the invention is characterized in that the base module includes at least one coffee grinder, a brewing unit, second means for producing hot water, a fluid interface for connecting a water connection line, an electrical interface for connecting a power cord, and third means for controlling the beverage preparation and dispensing operation.

In particular, the third means include an operating/control element.

Another embodiment is characterized in that one or more additional modules is/are accommodated in the housing and is/are in fluidic connection with the base module and/or the outflow module, and/or with one another via corresponding fluid interfaces.

In particular, the additional modules are electrically connected to the base module via corresponding electrical interfaces, and are supplied with electrical power via the base module, and their function is controlled by the third means of the base module.

According to another embodiment, the additional modules include one or more milk modules.

In particular, the beverage vending machine has an upper part and a lower part, the milk module(s) being situated in the lower part.

Another embodiment of the beverage vending machine according to the invention is characterized in that the additional modules include one or more syrup modules.

According to another embodiment, the additional modules include one or more powder modules.

However, it is also conceivable for the additional modules to include a cleaning module.

It is particularly advantageous when, according to another embodiment of the invention, the syrup modules or cleaning modules are exchangeably fastened in a suspended manner to a vertical wall inside the beverage vending machine.

In particular, the syrup modules and cleaning modules each have a mounting which is suspendable on the wall at a rear wall, and which is equipped with a bottom tray for adjusting a syrup container or cleaning agent container, and a pump housing having a syrup pump or cleaning agent pump situated therein.

Yet another embodiment is characterized in that the base module is accommodated in its own housing which in particular is protected from splashing water, and which is installed upright in the beverage vending machine above vibration-damping feet.

A pass-through opening for the coffee grounds is preferably situated beneath the brewing unit in the housing of the base module.

It is also advantageous when a bean hopper associated with the coffee grinder is situated above the at least one coffee grinder and outside the housing of the base module.

The outflow module according to the invention for a beverage vending machine according to the invention includes a support element, which is preferably angled and made of sheet metal, on which a detachable housing for conducting various fluids, in particular milk and/or air and/or steam and/or hot water and/or coffee, is fastened in a locking manner.

One embodiment of the outflow module according to the invention is characterized in that an exchangeable mixing chamber having a downwardly directed outlet for forming milk foam is provided.

In particular, a steam line, on the end of which the mixing chamber is attachable, extends in the housing.

The mixing chamber is preferably lockable on the housing in the manner of a bayonet lock.

Another embodiment of the outflow module is characterized in that a hot water outlet and a coffee line for dispensing hot water or coffee into a vessel standing beneath the outflow module are guided along the housing.

Another embodiment is characterized in that the support element has a base plate which supports the housing, and that openings for discharging syrup or a beverage that is mixed using powder are provided in the base plate.

### BRIEF DESCRIPTION OF THE FIGURES

The invention is explained in greater detail below with reference to exemplary embodiments in conjunction with the figures, which show the following:

FIG. 1 shows a simplified illustration of a beverage vending machine in a view from the front;

FIG. 2 shows the configuration of the various modules inside such a beverage vending machine according to one exemplary embodiment of the invention;

FIG. 3 shows a simplified wiring diagram for the electrical and fluidic cooperation of the individual modules in the beverage vending machine according to FIG. 2;

FIG. 4 shows a simplified block diagram of the various functional units in a base module according to FIG. 2;

FIG. 5 shows a perspective illustration of the actual configuration of the base module according to FIG. 2 together with the functional units according to FIG. 4;

FIG. 6 shows a perspective illustration of an example of a milk module according to FIG. 2, together with its essential functional elements;

FIG. 7 shows a perspective illustration of an example of a powder module according to FIG. 2, together with its essential functional elements;

FIG. 8 shows a perspective illustration of an example of a syrup module according to FIG. 2, together with its essential functional elements;

FIG. 9 shows two different perspective views (a) and (b) of an example of an outflow module according to FIG. 2, together with its essential functional elements; and

FIG. 10 shows an example of a cleaning module in an illustration comparable to FIG. 8.

### APPROACH(ES) FOR CARRYING OUT THE INVENTION

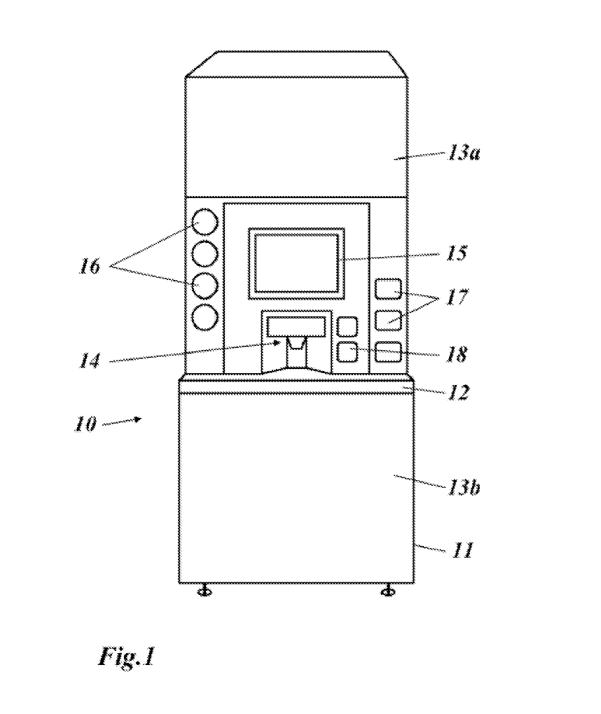

FIG. 1 shows a simplified illustration of an example of a beverage vending machine 10 in a view from the front, which is designed in the manner of the kiosk approach, explained at the outset, for dispensing and paying for coffee-based beverages.

The beverage vending machine 10 is accommodated in a housing 11 which has an upper part 13a and a lower part 13b which are separated by a panel 12 which forms a flat surface for dispensing the beverage. The actual beverage dispenser 14 is situated in a recessed space above the panel 12. Situated above the beverage dispenser is an operating/display unit 15 which is equipped with a touchscreen, for example, and which is used for selecting and displaying the beverage to be prepared. Cup receptacles 16 from which cups for receiving the beverage may be withdrawn are situated on the left side. Compartments 17 in which sugar, spoons, or the like are kept are situated on the right side. In addition, a payment unit 18 is provided which is used for paying for the selected beverage using coins or a chip card. Of course, the individual elements 14 through 18 may also be situated differently, or other elements may be additionally or alternatively provided.

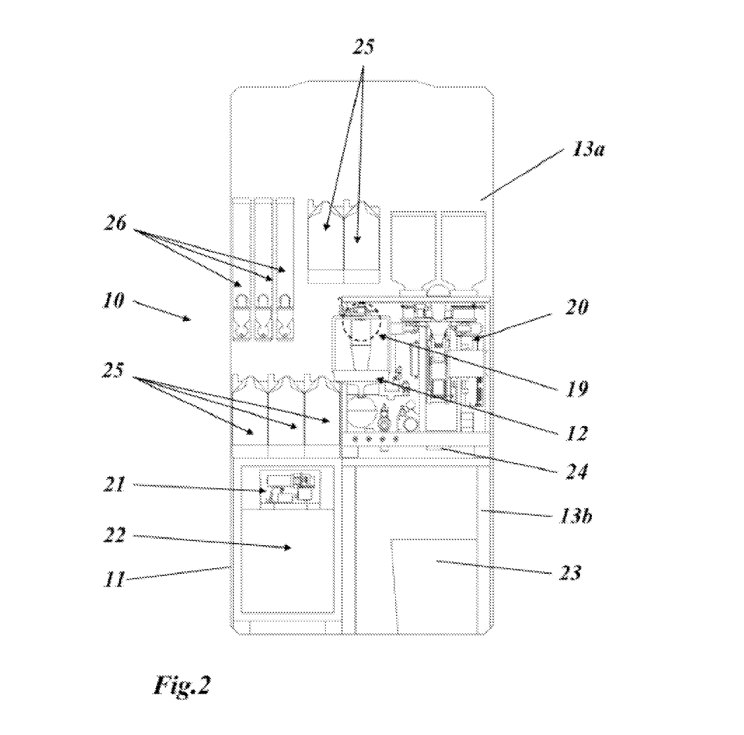

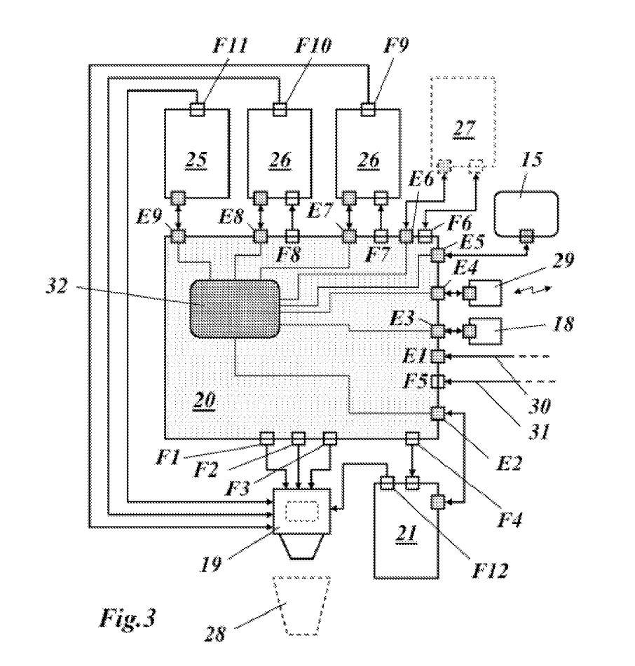

According to the present invention, the beverage vending machine 10 according to FIG. 1 is provided with an advantageous internal design, which is explained below with reference to the exemplary embodiment in FIG. 2 and the system diagram from FIG. 3.

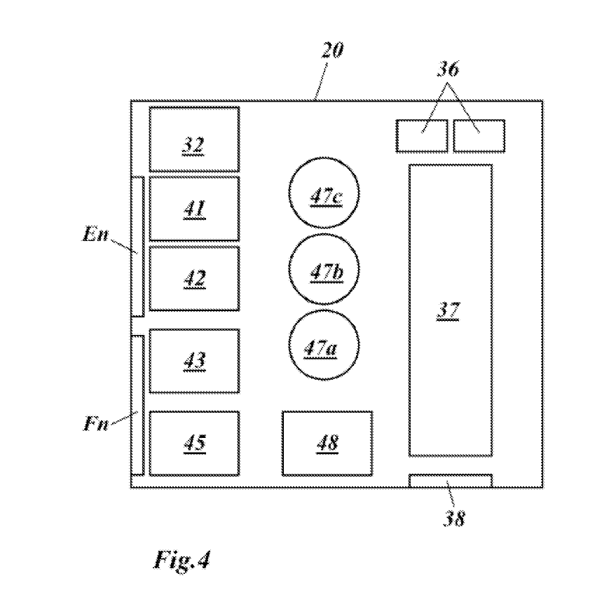

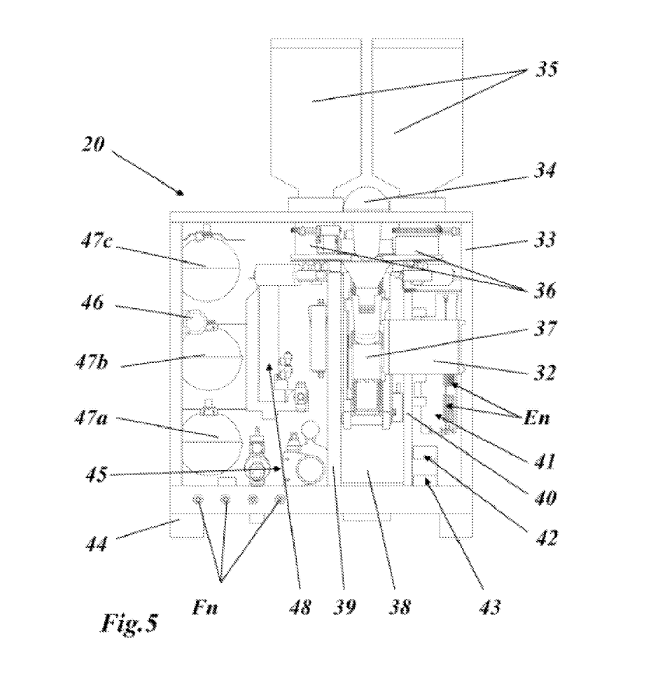

The key component of the internal design of the beverage vending machine according to FIG. 2 is a self-contained base module 20 which is designed for preparing a coffee beverage using freshly ground coffee, and whose functional units are illustrated schematically in FIG. 4, and illustrated in their actual configuration in FIG. 5. In addition to the base module 20, the basic equipment of the vending machine includes an outflow module 19 (discernible in FIG. 2 as a dotted-line circle) which is fluidically connected to the base module 20 via fluid interfaces (F1 through F3 in FIG. 3) and which is responsible for dispensing the coffee beverage into a cup 28 or the like standing therebeneath. Unlike the situation in conventional coffee machines, the outflow is not fixedly integrated into the machine (in the present case, the base module), but instead is provided separately as a module and is therefore independently placeable. As is apparent in FIG. 2, it is thus possible to move the base module 20 in the beverage vending machine from the center to the side, resulting in greater flexibility in the design of the vending machine.

In the exemplary embodiment according to FIGS. 2, 4, and 5, the base module 20 contains an operating/control element 32 for controlling the preparation of a beverage and monitoring the vending machine and the supplies of powder, syrup, coffee beans, etc. on hand. In addition, the base module 20 contains a brewing unit 37 which is provided for brewing coffee, and coffee grinders 36 which cooperate with the brewing unit 37 and by means of which different varieties of coffee may be ground and provided for the beverage preparation. A pass-through opening 38 is placed beneath the brewing unit, through which, when the brewing operation is complete, the residual coffee grounds may be ejected from the base module 20 into a larger coffee grounds container 23 located therebeneath (FIG. 2). The brewing unit 37 is preferably designed as a unit made completely of plastic, as is disclosed in the publications WO 93/02605 A1, WO 2009/027259 A2, or WO 2009/056426 A1, for example.

For the beverage preparation, three boilers 47a-c are provided in the base module 20 of the exemplary embodiment, the first boiler being used as a steam boiler, the second as a hot water boiler, and the third as a coffee boiler. A valve system 48 comprising multiple valves is provided for distributing water and steam. Fresh water is supplied via a water pump 45. Semiconductor relays (SSRs) 43 are responsible for controlling the boiler heaters and the water pump 45. Electrical power is supplied via a power supply unit 42 and a power section 41 downstream therefrom. Electrical interfaces En are provided for the connection to an electrical power grid and for the electrical connection to other modules within the beverage vending machine. Fluid interfaces Fn are provided for the connection to a water line and the fluidic or hydraulic connection to other modules within the beverage vending machine.

The base module 20 is the “heart” of the beverage vending machine, and contains all components that are necessary for producing coffee and steam. In addition, the base module contains the complete intelligence system for the entire device, and has the various interfaces En and Fn by means of which other modules in the vending machine may be fluidically and electrically connected to the base module 20.

According to FIG. 5, the base module 20 is accommodated in a stable housing 33 which may be opened from the front. A slot opening 34 for cleaning tablets is situated on the top side of the housing 33, above the brewing unit 37. The pass-through opening provided beneath the brewing unit 37 for passing through the coffee grounds is protected from contact by the hand. For safety reasons, the housing 33 is not openable without a tool. Only the brewing chamber together with the brewing unit 37 can be opened without a tool, so that the brewing unit may be cleaned. Monitoring by safety switches may be provided. In addition, the housing 33 is sealed off to the extent necessary for passing an overflow test. In the interior, the base module 20 has a subdivision by means of a partition wall 39 and a protective housing 40, so that water-conducting parts, the brewing chamber together with the brewing unit 37, and the electronics system are separated from one another. In particular, the bean hoppers 35 situated above the coffee grinder 36, and the coffee grinder 36 itself, are thermally separated from the boilers 47a-c by the partition wall 39.

The boilers 47a-c are preferably designed as spherical boilers, and in each case have connected loads of 2 kW, 3 kW, or 6 kW and a capacity of approximately 1 liter. The boilers are mounted in the base module 20 so as to be easily exchangeable, and are monitored by manometers 46 (FIG. 5) which are visible from the outside.

The electrical interfaces En (n=continuous index) may be specified as follows:

Ethernet; a separate GUI may be connected via the Ethernet;

MDB billing interface;

USB; connection of communication modules such as IrdA, WLAN, etc.;

RS485; depending on the module architecture selected, this interface is used for connection to additional modules;

I/O for modules; depending on the module architecture selected, this interface is used for connection to additional modules;

Alarm outputs;

24 VDC for additional modules;

Monitoring of the coffee grounds container 23;

Supply voltage for additional modules;

Power grid line (1-phase or 3-phase).

Fluid interfaces Fn (n=continuous index) may be specified as follows:

Coffee; interface for brewed coffee to the outflow module 19 (F1 in FIG. 3);

Hot water; interface for hot water to the outflow module 19 (F2 in FIG. 3);

Steam; interface evaporates to the outflow module 19 (F3 in FIG. 3);

Powder; interfaces for hot water to the powder modules 26 (F7, F8 in FIG. 3);

Fresh water; interface for the connection of fresh water (F5 in FIG. 3);

Cleaning agent; interface for coffee cleaning (optional).

As is apparent from FIG. 5, the fluid interfaces Fn are situated at the bottom of the housing 33 of the base module 20, while the electrical interfaces En are accessible from the side. The base module 20 together with its housing 33 is mounted upright in the beverage vending machine 10 at the level of the panel, above vibration-damping feet 44 (FIGS. 2, 5). The body vibrations emanating from the coffee grinders 36 are thus additionally decoupled from the housing 11 of the vending machine.

In addition to the outflow module 19, additional modules cooperate with the base module 20 and are controlled by same, and are fluidically connected to the base module or to the outflow module 19, or also to one another via corresponding fluid interfaces. In the exemplary embodiment in FIG. 2, five syrup modules 25, three powder modules 26, and one milk module 21 are provided as additional modules. The syrup modules 25 are fluidically connected to the outflow module 19, and dispense predefined quantities of syrup, for example for flavoring the coffee beverage. The powder modules 26 keep beverage powders, which together with cold or hot water are used for preparing other beverages such as tea or the like. The milk module 21 is situated beneath the panel in the lower part 13b of the beverage vending machine, and conveys milk from a milk container which is stored under refrigeration in a cooling unit 22 situated therebeneath.

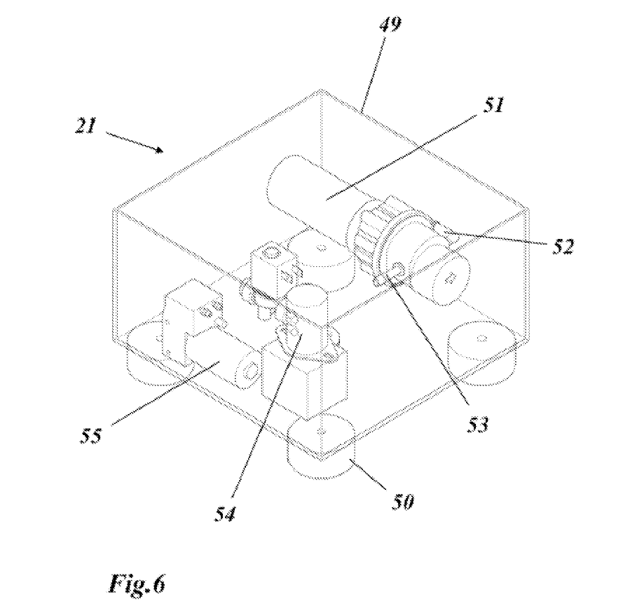

The example of the design of a milk module 21 is shown in FIG. 6. A milk pump 51 which draws in milk via a suction hose 52 from the milk container located therebeneath and dispenses it via a conveying hose 53 is horizontally situated in a housing 49 which is mounted upright on vibration-damping feet 50. A pinch valve 54 allows switching between pumping milk and flushing the milk-conducting lines. To be able to foam the milk independently of steam, an air pump 55 is additionally provided in the milk module 21 which introduces compressed air into the milk for foaming.

The milk module 21 has electrical interfaces for the milk pump 51, the pinch valve 54, the air pump 55, a level sensor on the milk container, and optionally a flush valve. A fluid interface is present for supplying flush water (fluid interface F4 in FIG. 3). A further fluid interface (F12) involves the connection for the milk to the outflow module 19.

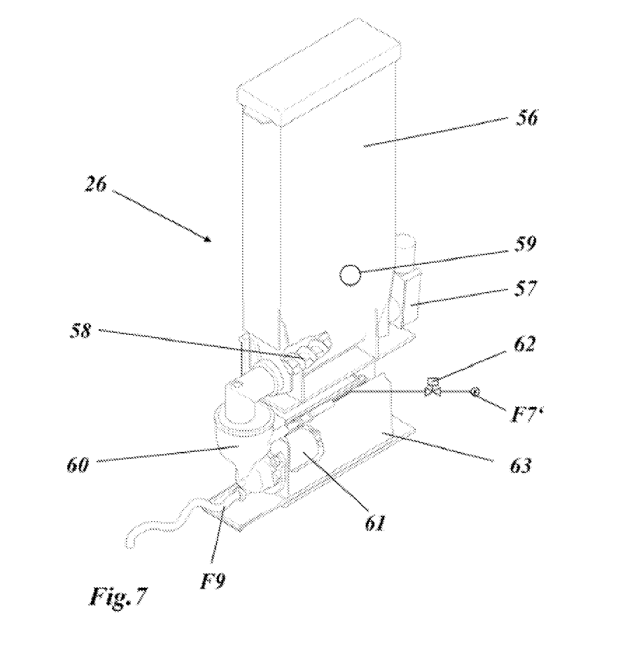

The example of the design of a powder module 26 is shown in FIG. 7 in a partially cutaway illustration. Water which flows into a mixer funnel 60 is supplied to the powder module 26 via a fluid interface FT having a controllable water valve 62. Powder from a powder container 56 is conveyed by a screw conveyor 58, which is driven by a conveyor motor 57, into the mixer funnel 60 from above. Beneath the mixer funnel 60, the mixture of water and powder is mixed by means of a mixer motor 61 and then discharged to the outflow module 19 via a fluid interface F9 (or F10 in FIG. 3). The powder module 26 is accommodated in a housing 63 and fastened in a suspended manner to a vertical wall in the beverage vending machine. The powder container 56 has a capacity of 4 liters, for example, and is equipped with a level sensor 59. Electrical interfaces En involve the mixer motor 61, the conveyor motor 57, the water valve 62, and the level sensor 59. The fluid interface F7′ is provided for supplying hot water.

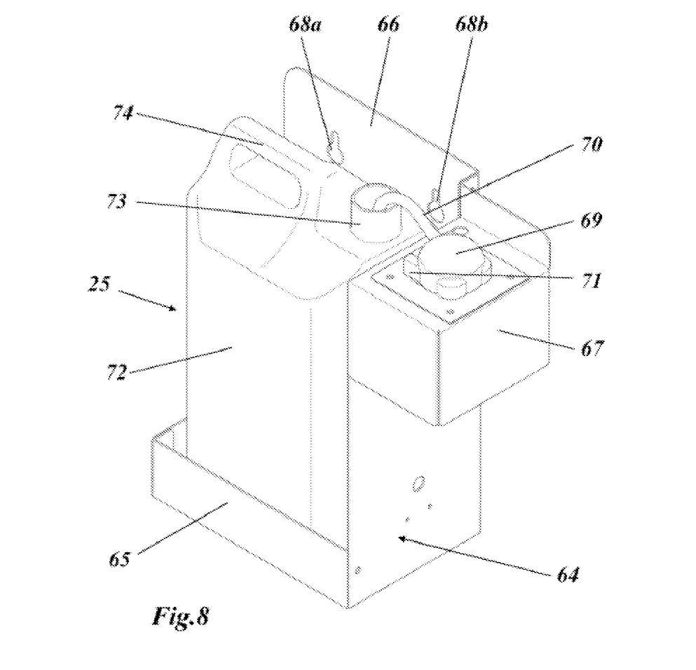

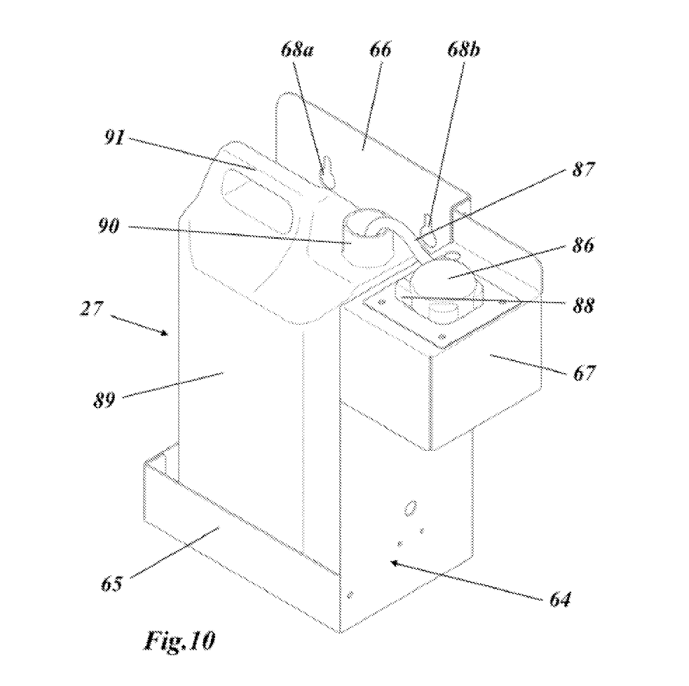

The syrup module 25 (FIG. 8) and the cleaning module 27 (FIG. 10) have the same design. In both cases, a mounting 64 is provided which has a vertical rear wall 66 with mounting holes 68a, b, and a bottom tray 65 into which a syrup container 72 or a cleaning agent container 89 may be exchangeably inserted. A pump housing 67 in which a syrup pump 69 or a cleaning agent pump 86 is accommodated is situated at the side of the mounting 64. The pumps 69, 86 draw in syrup or cleaning agent from the respective container 72 or 89 via a suction hose 70 or 87, respectively, above a dispenser opening 73 or 90, respectively, and discharge it to a corresponding fluid interface via a pump outlet 71 or 88, respectively. The container 72 or 89 is provided with a carrying handle 74 or 91, respectively, for easily exchanging the container. Syrup modules and cleaning modules as well as the powder modules may be easily mounted on the same wall in a suspended manner by means of the mounting holes 68a, b. By selecting the modules, the overall system may thus be adapted to different requirements in a very simple and flexible manner. Likewise, modules may be exchanged very easily.

The syrup modules 25 have electrical interfaces for the syrup pump 69 and a level sensor (E9 in FIG. 3), and a connection to the outflow module 19 (F11 in FIG. 3) as a fluid interface.

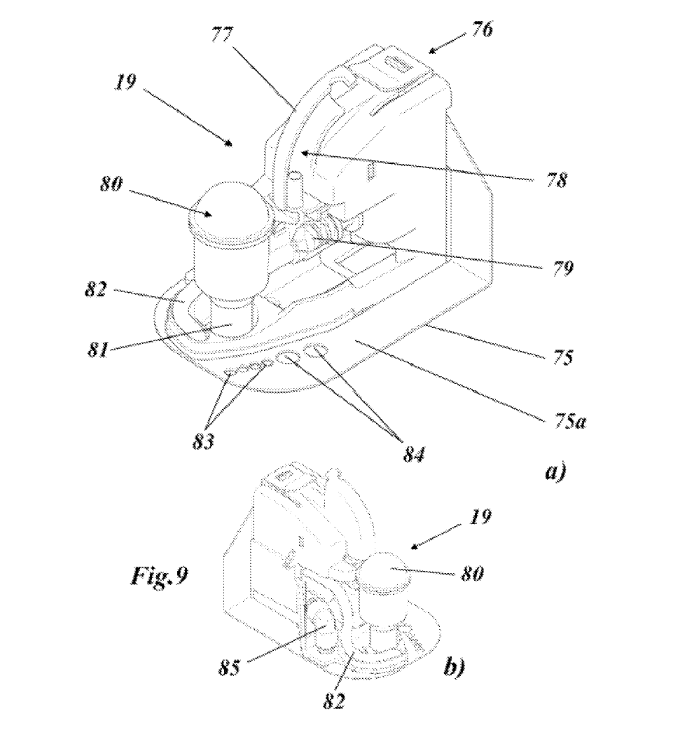

The design and the configuration of the outflow module 19 illustrated in FIG. 9 are of particular importance. The outflow module 19 includes an angled support element 75 made of sheet metal, having a horizontal base plate 75a. A housing 77 made of plastic is detachably mounted on the horizontal base plate 75a and held in a locking manner by means of a detent device 76. The housing 77 is provided for conducting various fluids, in particular milk and/or air and/or steam and/or hot water and/or coffee.

The outflow module 19 has an exchangeable mixing chamber 80 for mixing milk or milk/air with steam to form milk foam, the mixing chamber being provided with a downwardly directed outlet 81. A steam line 79, on the end of which the mixing chamber 80 is attachable, extends in the housing 77, the mixing chamber 80 being lockable on the housing 77 in the manner of a bayonet lock. The design, function, and attachment correspond to the disclosure in the publication DE 20 2011 05 17 19.5 (German Utility Model).

In addition, a hot water outlet 85 and a coffee line 82 for dispensing hot water or coffee into a vessel (cup 28) standing beneath the outflow module 19 are guided along the side of the housing 77. For discharging syrup (from the syrup modules 25) or a beverage which is mixed using powder (from the powder modules 26), lateral openings (syrup channels 83, powdered beverage channels 84) are provided in the base plate 75a through which syrup or powdered beverages may be dispensed into the cup 28 by means of elements (pipes, etc.) which are not illustrated.

The cooperation of the base module 20, the outflow module 19, and the other modules 21, 25, 26, and 27 is illustrated in FIG. 3 in the manner of a wiring diagram together with the associated electrical interfaces En and fluid interfaces Fn. Water is supplied to the base module 20 via a water connection line 31 and the fluid interface F5. Power is supplied to the base module 20 via a power cord 30 and the electrical interface E1.

The milk module 21 receives flush water from the base module 20 via the fluid interface F4, and discharges milk to the outflow module 19 via the fluid interface F12. The supplying of power and exchanging of signals take place via the electrical interface E2.

A syrup module 25 (by way of example) is electrically connected to the base module 20 via the electrical interface E9, and discharges syrup to the outflow module 19 via the fluid interface F11.

The two powder modules 26 are electrically connected to the base module 20 via the electrical interfaces E7 and E8, and receive hot water from the base module 20 via the fluid interfaces F7 and F8 and discharge the prepared beverages to the outflow module 19 via fluid interfaces F9 and F10.

An optional cleaning module 27 is connected to the base module via the electrical interface E6, and feeds cleaning agent into the base module 20 via the fluid interface F6.

An external operating/display unit (GUI) may be connected to the central operating/control element 32 via the electrical interface E5. Likewise, a communication module 29 which operates wirelessly may be connected via an electrical interface E4. Lastly, a payment unit 18 is connected to the base module 20 via the electrical interface E3.

### LIST OF REFERENCE NUMERALS/CHARACTERS

10 Beverage vending machine

11 Housing

12 Panel

13a Upper part

13b Lower part

14 Beverage dispenser

15 Operating/display unit (touchscreen, for example)

16 Cup receptacle

17 Compartment

18 Payment unit

19 Outflow module

20 Base module

21 Milk module

22 Cooling unit

23 Coffee grounds container

24 Drop opening

25 Syrup module

26 Powder module

27 Cleaning module

28 Cup

29 Communication module

30 Power cord

31 Water connection line

32 Operating/control element

33 Housing (base module)

34 Slot opening (for cleaning tablets)

35 Bean hopper

36 Coffee grinder

37 Brewing unit

38 Pass-through opening

39 Partition wall

40 Protective housing (electrical system)

41 Power section

42 Power supply unit

43 Semiconductor relay (SSR)

44, 50 Foot (vibration-damping, for example)

45 Water pump

46 Manometer

47a-c Boiler

48 Valve system

49 Housing (milk module)

51 Milk pump

52 Suction hose

53 Conveying hose

54 Pinch valve

55 Air pump

56 Powder container

57 Conveyor motor

58 Screw conveyor

59 Level sensor

60 Mixer funnel

61 Mixer motor

62 Water valve

63 Housing

64 Mounting (syrup module, cleaning module)

65 Bottom tray

66 Rear wall

67 Pump housing

68a, b Mounting hole

69 Syrup pump

70 Suction hose

71 Pump outlet

72 Syrup container

73 Dispenser opening

74 Carrying handle

75 Support element (angled)

75a Base plate (support element)

76 Detent device

77 Housing

78 Milk/air duct

79 Steam line

80 Mixing chamber

81 Outlet (mixing chamber)

82 Coffee line

83 Syrup channel

84 Powdered beverage channel

85 Hot water outlet

86 Cleaning agent pump

87 Suction hose

88 Pump outlet

89 Cleaning agent container

90 Dispenser opening

91 Carrying handle

E1-E9 Electrical interface

F1-F12 Fluid interface

F7′ Fluid interface

1-21. (canceled)

22. Beverage vending machine having a housing in which first means for brewing and dispensing a coffee beverage prepared using freshly ground coffee are accommodated, characterized in that the first means have a modular construction and include at least one base module for brewing the coffee beverage, and a separate outflow module for dispensing the coffee beverage, which are in fluidic connection with one another via one or more fluid interfaces, and that the base module includes at least one coffee grinder, a brewing unit, second means for producing hot water, a fluid interface for connecting a water connection line, an electrical interface for connecting a power cord, and third means for controlling the beverage preparation and dispensing operation.

23. Beverage vending machine according to claim 22, characterized in that the third means include an operating/control element.

24. Beverage vending machine according to claim 22, characterized in that one or more additional modules is/are accommodated in the housing and is/are in fluidic connection with the base module and/or the outflow module, and/or with one another via corresponding fluid interfaces.

25. Beverage vending machine according to claim 24, characterized in that the additional modules are electrically connected to the base module via corresponding electrical interfaces, and are supplied with electrical power via the base module, and their function is controlled by the third means of the base module.

26. Beverage vending machine according to claim 24, characterized in that the additional modules include one or more milk modules.

27. Beverage vending machine according to claim 26, characterized in that the beverage vending machine has an upper part and a lower part, and that the milk module(s) is/are situated in the lower part.

28. Beverage vending machine according to claim 24, characterized in that the additional modules include one or more syrup modules.

29. Beverage vending machine according to claim 24, characterized in that the additional modules include one or more powder modules.

30. Beverage vending machine according to claim 24, characterized in that the additional modules include a cleaning module.

31. Beverage vending machine according to claim 28, characterized in that the additional modules include a cleaning module and in that the syrup modules or the cleaning module are exchangeably fastened in a suspended manner to a vertical wall inside the beverage vending machine.

32. Beverage vending machine according to claim 31, characterized in that the syrup modules and the cleaning module each have a mounting which is suspendable on the wall at a rear wall, and which is equipped with a bottom tray for adjusting a syrup container or cleaning agent container, and a pump housing having a syrup pump or cleaning agent pump situated therein.

33. Beverage vending machine according to claim 22, characterized in that the base module is accommodated in its own housing which in particular is protected from splashing water, and which is installed upright in the beverage vending machine above vibration-damping feet.

34. Beverage vending machine according to claim 33, characterized in that a pass-through opening for the coffee grounds is situated beneath the brewing unit in the housing of the base module.

35. Beverage vending machine according to claim 33, characterized in that a bean hopper associated with the coffee grinder is situated above the at least one coffee grinder and outside the housing of the base module.

36. Outflow module for the beverage vending machine according to claim 22, including a support element, which is preferably angled and made of sheet metal, on which a detachable housing for conducting various fluids, in particular milk and/or air and/or steam and/or hot water and/or coffee, is fastened in a locking manner.

37. Outflow module according to claim 36, characterized in that an exchangeable mixing chamber having a downwardly directed outlet for forming milk foam is provided.

38. Outflow module according to claim 37, characterized in that a steam line, on the end of which the mixing chamber is attachable, extends in the housing.

39. Outflow module according to claim 37, characterized in that the mixing chamber is lockable on the housing in the manner of a bayonet lock.

40. Outflow module according to claim 36, characterized in that a hot water outlet and a coffee line for dispensing hot water or coffee into a vessel standing beneath the outflow module are guided along the housing.

41. Outflow module according to claim 36, characterized in that the support element has a base plate which supports the housing, and that openings for discharging syrup or a beverage that is mixed using powder are provided in the base plate.
